(19) United States
(12) Patent Application Publication
(10) Pub. No.: US 2007/0038486 A1
(43) Pub. Date: Feb. 15, 2007

(54) Methods and systems for candidate information processing

(76) Inventor: Greg Mohn, Eden Prairie, MN (US)

Correspondence Address: Fulbright & Jaworski LLP;Attn: John Klos, Suite 2100, 80 S. 8th Street, Minneapolis, MN, 55402, US

(21) Appl. No.: 11/501,903

(22) Filed: Aug. 8, 2006

Related U.S. Application Data
(60) Provisional application No. 60/706,948, filed on Aug. 9, 2005.

(51) Int. Cl. G06Q 40/00

(52) U.S. Cl. 705/4

(57) ABSTRACT

A system and method for systematically managing a detailed policy of appropriate action for acquired background data that may contain predetermined discrepancies. A process evaluates discrepancy data against an adaptable policy mapping engine and provides an action set for further processing of a candidate for employment. A notification mapping engine identifies the appropriate steps to be taken, persons to be notified and message to be delivered to candidate. The two mapping engines can be customized to a specific employer and are subsequently adaptable to reflect changes suggested by a report generated by the system.

### RELATED APPLICATION:

This application claims the benefit of U.S. Provisional Application No. 60/706,948, filed Aug. 9, 2005.

### TECHNICAL FIELD

The invention relates to candidate information processing and more particularly to an adaptable system and method for processing background information in an efficient and accurate manner.

### BACKGROUND OF THE INVENTION

Pre-employment and employee screening has typically included a subjective analysis of background information, particularly when criminal background information is being evaluated. Inherently, there are inconsistencies in the process due to its subjective nature, and often certain valuable information were either not factored into the screening process or were given insufficient weight. However, with both federal and state legal requirements mandating certain types of background checks be performed for certain positions and with more employers being wary of the type of people they employ, the pre-employment/employment screening process must now become a more objective process. Furthermore, in order to shield against litigation alleging unfair hiring practices, the exists a need to document and verify hiring and employment criteria and screening.

Evaluation of applicants for new employee positions, or current employees for potential advancement requires the assessment of an increasing number of variables. Factors such as criminal background, employment history, and other items frequently requested on applicant/employee forms are typically considered on an ad hoc basis by potential employers. Evaluation of criminal backgrounds is especially problematic given the vast array of state, federal and/or municipal offenses. As there are no standard definitions for many criminal offenses, past screening approaches have been particularly subjective.

Employers in different levels of service and in different professions may assign different weights to certain criteria, such as a motor vehicle offense being very relevant in a driving-related position whereas it may make no difference in a manual labor environment. Accordingly, each industry, and even each employer, optimally may be able to consider factors on its own weighted scale. Increasingly, companies must verify information from increasing numbers of divergent sources.

The prior art method of handling these inquires is typically a hand review of information, often with multiple reviewers evaluating the information of a pool of candidates for the same employer. In such approaches, consistency of evaluation is a difficult, if not unattainable, goal. An automated method of screening applicant's characteristics with variable weighting is needed.

There have been prior art systems which provided aid in the candidate/employee screening process. However, most of these systems only provided an automated method of gathering background information from the candidate/employee or governmental agencies. These prior art systems may also format this background information into a more organized and decipherable format. However, there appears to be a need in the art for a system which is able to acquire and evaluate background information and provide an objective and systematic assessment and also a handling protocol of that information. For example, there exists a need for notifying the appropriate personnel if certain discrepancies in a candidate/employee background information require special action be taken. Consequently, there is a need for a system and method wherein pre-set criteria is used to objectively evaluate a candidate/employee background information. Furthermore, there is a further need for a system and a method wherein discrepancies in a candidate's/employee's background information would automatically notify the appropriate person. Yet another need exists for a system capable of generating reports which may be utilized to modify the decision or policy maps to increase or decrease the pool of viable candidates.

Therefore, it would be desirable to provide a more effective and inexpensive system and method for collecting, evaluating and processing information for job candidates. It would be also desirable to provide such a system that is substantially automated and that is used early in the hiring process.

### BRIEF SUMMARY OF THE INVENTION

The present invention is directed to systems and methods for processing information relating to an individual and/or pool of candidates in an efficient, consistent and accurate manner. An important aspect of the invention is the adaptability of the various modules either during initial installation and/or subsequent to installation. As described in more detail herein, policy mapping modules and notification mapping modules may be adapted depending on a particular employers needs.

Embodiments of the invention include steps or processes for creating custom policy and notification maps with consultation of the employer and acquiring data about an applicant from external information sources. Further processes include receiving data concerning the applicant from the external information sources and evaluating the received candidate data against the policy maps for the employer, for example, data received from the external information sources can be evaluated against a customized set of policy rules determined by an employer.

In other aspects, the invention relates to a method for evaluating a pool of candidates for employment, comprising: steps for requesting information about the applicants for employment from external information sources; steps for receiving data concerning the applicants from the external information sources; steps for evaluating the applicants based on evaluation of the data received from the external information sources against a custom policy map; and steps for notification directing the employer or designee with instructions for further processing of each candidate of the pool. In other aspects, an embodiment of the present invention may be integrated with or in communication with an employer's HMRS/HRIS systems.

Advantages of the present invention include an accurate automated process for evaluating applicants for employment against a customized policy map and for post-evaluation processing of the applicants. Other advantages include minimizing human judgment from the applicant evaluation and post-evaluating processing processes in order to reduce the risk of bias and discrimination. Other aspects and advantages of the invention will be apparent from the following description and the appended claims.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an overview of an embodiment of the present invention;

FIG. 2 is a process diagram of an embodiment of the present invention;

FIGS. 3-5 show examples of an employer's policy mapping matrix;

FIGS. 6 and 7 show various external sources of information suitable for use with the present invention;

FIG. 8 shows an embodiment of a notification key which associates actions with particular people within an organization;

FIGS. 9 and 10 are examples of various text suitable for use with an embodiment of a notification module according to the present invention.

### DETAILED DESCRIPTION OF THE INVENTION

An embodiment of the present invention provides an automated candidate screening method and system, wherein a candidates/employee background information is screened objectively and automatically by utilizing user-defined screening criteria. Furthermore, user-defined actions, such as notification processes, can be implemented based upon the results of the screening process. For the purpose of explanation only, the subject invention is described in the context of evaluating background checks. It will be clearly apparent to one skilled in the art, that the subject invention may be utilized to evaluate different forms of candidate/employee background information without deviating from the scope and breadth of the subject invention.

Embodiments of the invention provide an automated screening system for employment applicants with customer-specific, variable weighting. Such a system allows an external customer to efficiently and effectively evaluate one candidate or a pool of employment candidates. As further described herein, the customer-defined and/or customer-specific policy map defines a series of rules for evaluating the candidate or pool of candidate.

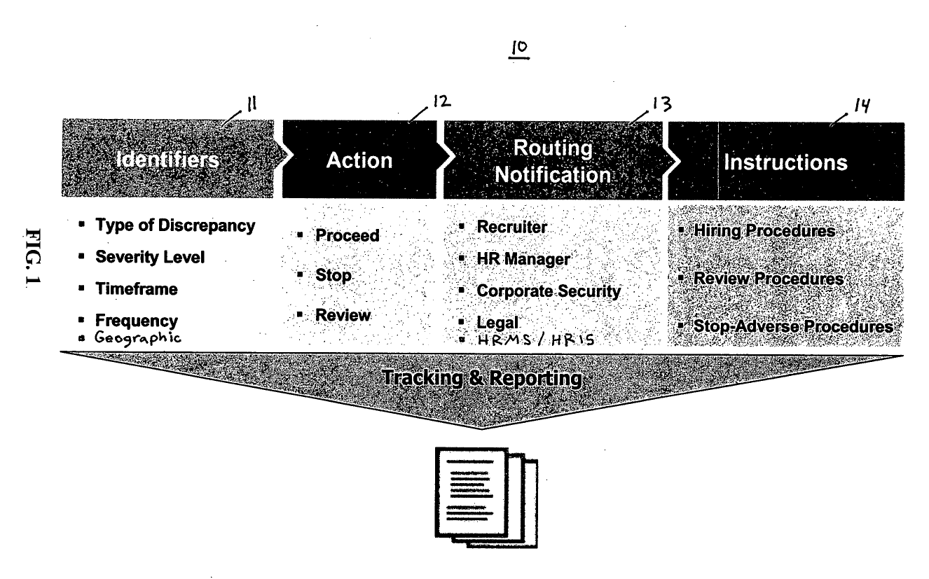

FIG. 1 is an overview of one embodiment 10 of a process in accordance with the present invention. Process 11 determines discrepancies in a candidate's and/or a pool of candidates' background information and the severity of the discrepancies as defined by a user. As the term is used herein, “discrepancy” is defined to include a variety of data types, including but not limited to, criminal background, names, past and present addresses, education, credit record, driving record and job history, that are of interest to a prospective employer. A candidate with no discrepancies may receive a “proceed” status, while another candidate with one or more discrepancies may receive a “review” or “stop” status depending on the particulars of a customized policy map. Process 11 also determines the time frame and frequency of past discrepancies. Process 11 may also determine the geographic location of a discrepancy, for subsequent comparison to policy maps having geographic specific constraints, such as location of an offense relative to an anticipated work site or relative to the employer's place of business. For example, some jurisdictions (Federal, State or local) may prohibit employment of a candidate within a given industry or location depending on the type and/or location of a past offense. For example, a local regulation may prohibit employment of a candidate within a Philadelphia school if the candidate was convicted of driving offense within the past year.

Process 12 defines appropriate user-defined actions that are related to the type and severity of the discrepancy found in process 11. This information is then routed to one or more people and/or system based on the type of action that is required. For example, a system of the invention can provide instructions to personnel of the appropriate procedures for handing each candidate within the pool of candidates, as indicated by process 13. The user is able to define, refine and/or modify policy maps, notification maps and instruction sets which are used by the system to process a pool of candidate's background information at process 14.

One important advantage of the present invention is the ability to allow the user to adjust the weighting of the characteristics used to evaluate the applicant. These individual weighting schemes are within the policy mapping engine. The policy maps are created and stored for each customer/user based on customer preferences. Multiple policy maps may be stored for a single customer/user for different employment positions such as hourly, salaried, clerical, accounting, etc.

Another important advantage of the present invention is the ability to allow the user to customize notification maps used in post-evaluation processing. Notification maps can include personnel lists, contact information, communication protocol, timing, etc.

Yet another important advantage of the present invention is the ability to provide reports to a user summarizing the evaluation processing for a pool of employment candidates. A user may modify the mapping engine(s) based on these reports to, for example, provide for a reduction or enlargement of candidates being positively processed. After the policy maps and notification maps are established in the system, a user may initiate a screening request for an applicant or a pool of applicants. User access of the system may be via the internet, although other computer or automated networks may be used.

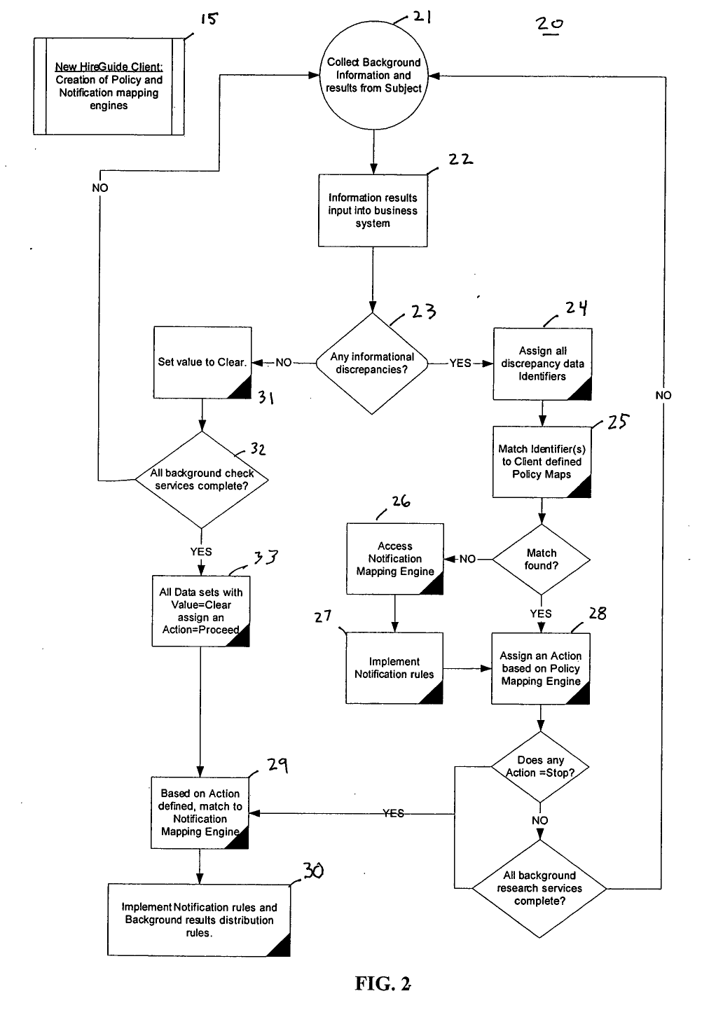

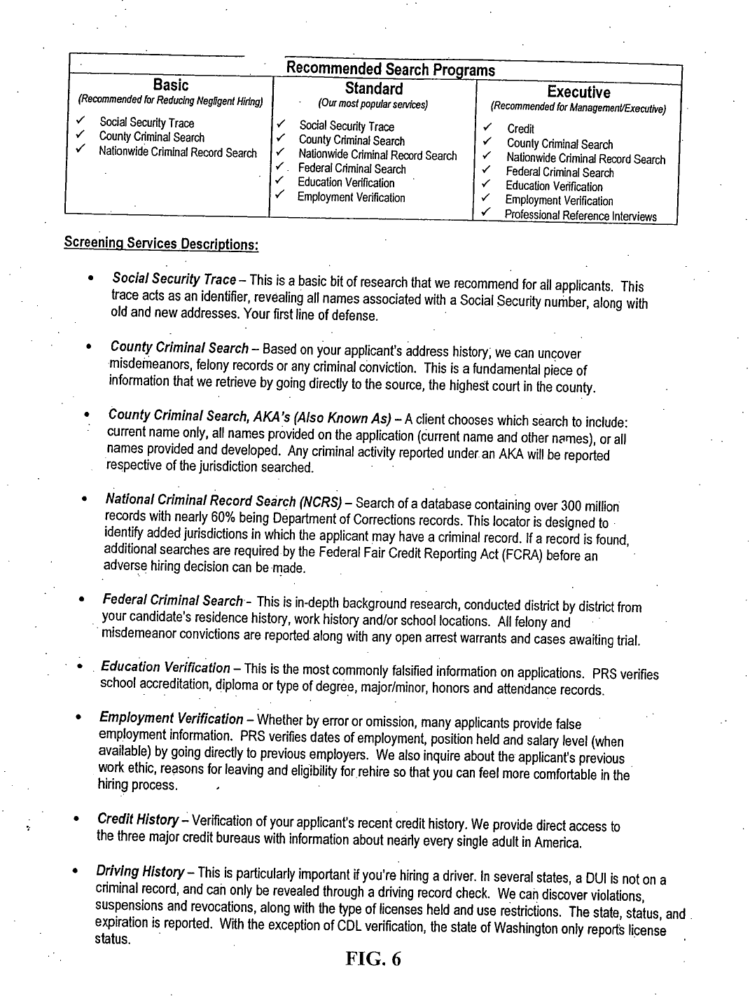

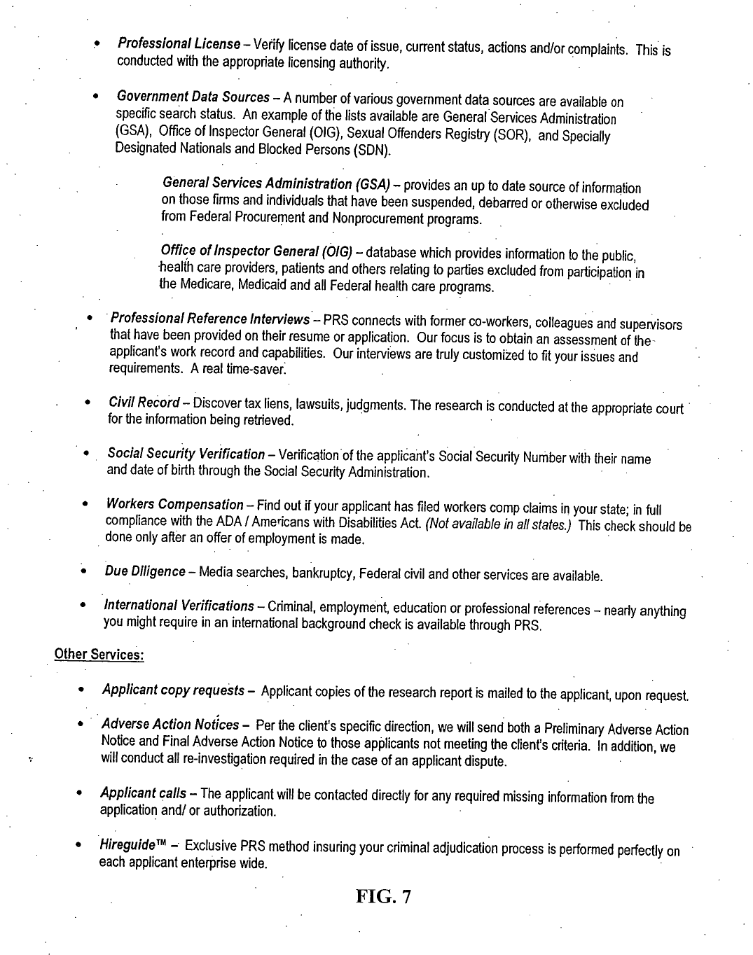

FIG. 2 is a top-level process diagram 20 of an embodiment of the invention wherein data or other information used for evaluating a “discrepancy” in a candidates background information are loaded onto the system at process 21. Process 15 creates and customizes policy and notification mapping engines. Data can be obtained from a variety of sources, including, but not limited to, the various data sources listed in FIGS. 6 and 7. The collected information is input into a memory at process 22.

The existence of information discrepancies is determined at process 23. When information discrepancies exist, the background discrepancies are assigned data identifiers at process 24. These data identifiers are matched to client defined policy maps at process 25. If no match is found, process 26 accesses a notification mapping engine and process 27 implements a notification action based on data from process 26. If a match is found, actions are assigned with reference to the customer policy maps at process 28. Additionally, process 28 may be accessed when a match is not found though after access to process 26 and process 27. Based on the actions of process 28 and upon completion of the project or receipt of a “STOP” action, the notification mapping engine is accessed at process 29 and notification instructions are implemented at process 30. The appropriate contact persons could be linked to the particular action (although not necessarily required). The appropriate procedures to take can also be linked to the particular identifier or action or contact person.

Returning to process 23, if no discrepancies exist for a candidate within a given data record, a value of CLEAR is assigned to the candidate at process 31 and either additional data records are evaluated (process 32) or, if no additional data records are available for the candidate, a value of PROCEED is associated with the candidate that at process 33. Processes 29 and 30 may then be accessed to provide actions and/or notification for those candidates designated with PROCEED status.

In the case of multiple available data records, the process of FIG. 2 may be repeated for each data record. In the end, each candidate may be designated with one or more “PROCEED” designations and/or one or more “STOP” or “REVIEW” designations. The notification mapping engine is accessed to provide one or more instructions for further processing of the candidate.

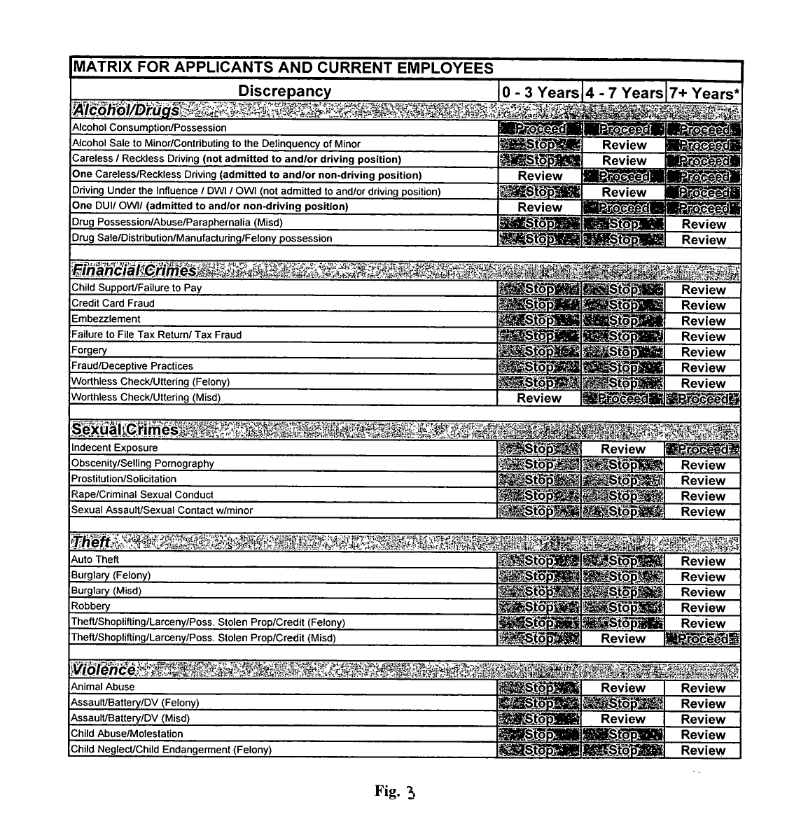

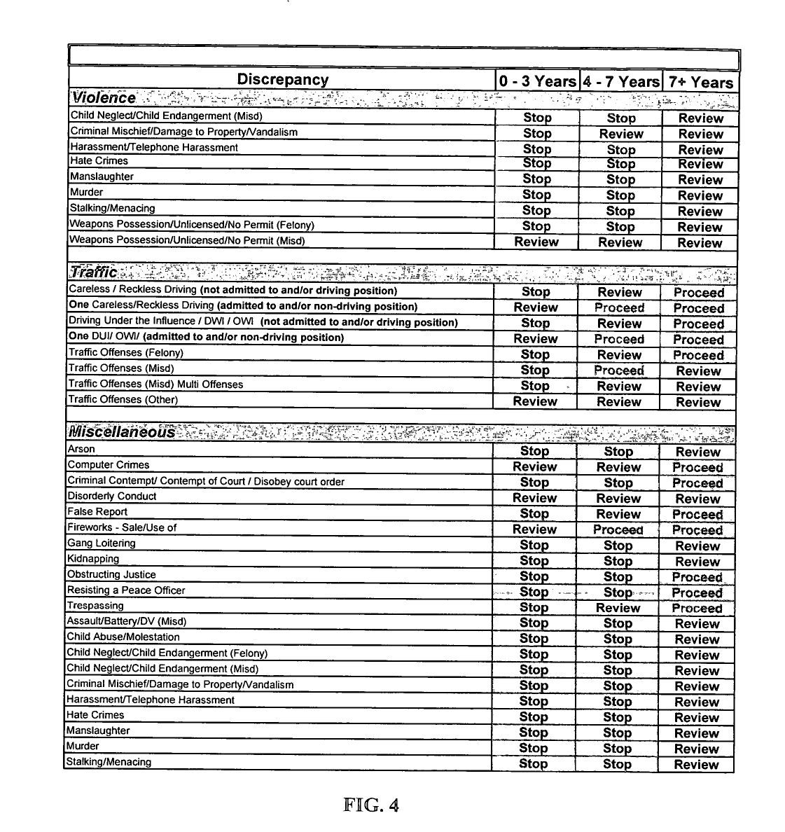

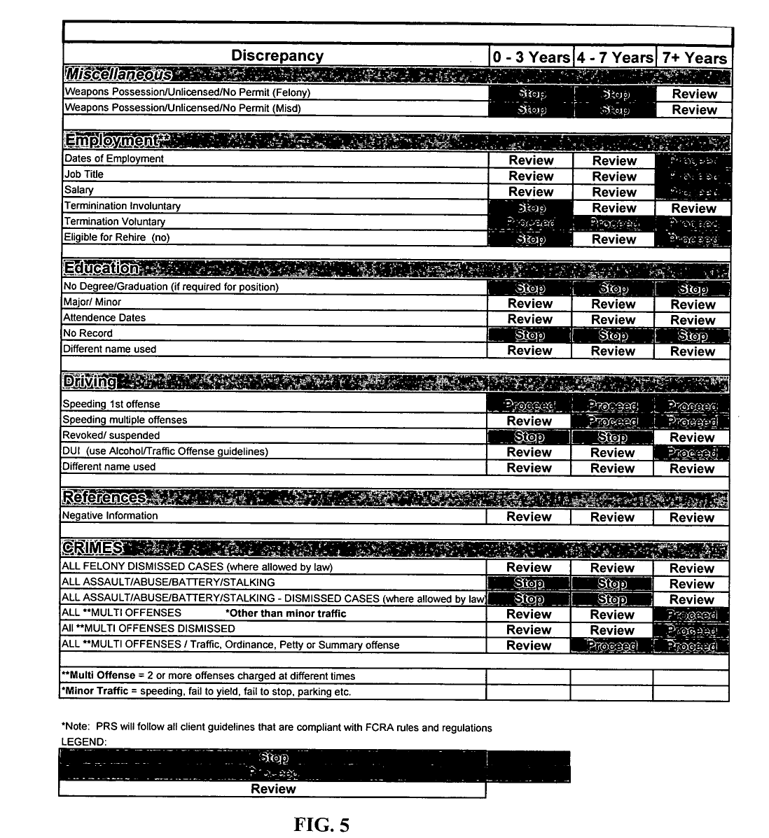

In one embodiment, evaluation of the discrepancies and the appropriate actions to take with respect to them can be determined by using a matrix. The information from the background checks may be evaluated using search engines. This information may be evaluated with respect to the matrix (as shown in FIGS. 3-5) which links an identifier for the discrepancy with the timeframe of the discrepancy, and with an appropriate action in response to the discrepancy. The action may be based upon a number of criteria such as the severity of the discrepancy, the timeframe of when the discrepancy was committed, the frequency of which the discrepancy is committed, and other significant circumstances. Other means for linking the discrepancies with an appropriate action can be readily used. Means such as pointers, data chains, and other data formats may be used to link the discrepancy with the appropriate actions.

As shown in FIG. 2, after the system is updated with the appropriate information, a candidate's background checks are filtered using matrix information of a policy map, such as shown in FIGS. 3-5. Some of the background checks which can be utilized by the system include those found in FIGS. 6 and 7. The background checks may be filtered by the system once they are all accumulated. As many of the different background checks can be assimilated into the subject invention electronically, it may be preferable that the system automatically update the candidate's/employee's file as each of the different background checks are completed. Consequently, the candidate/employees files are maintained without the need to constantly monitor the results of the different background checks taken.

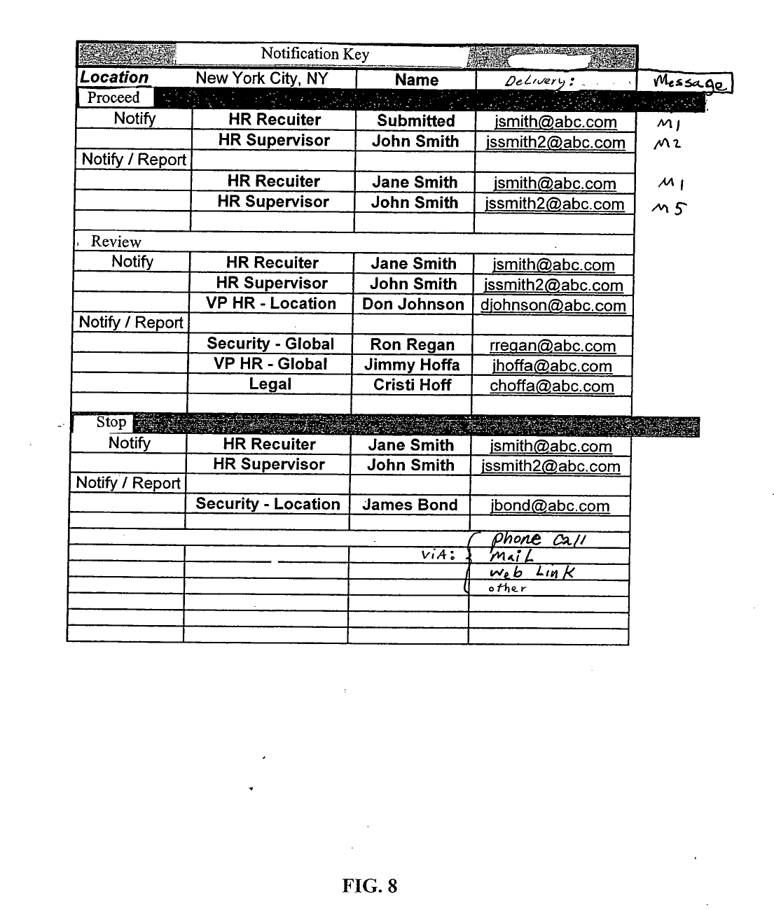

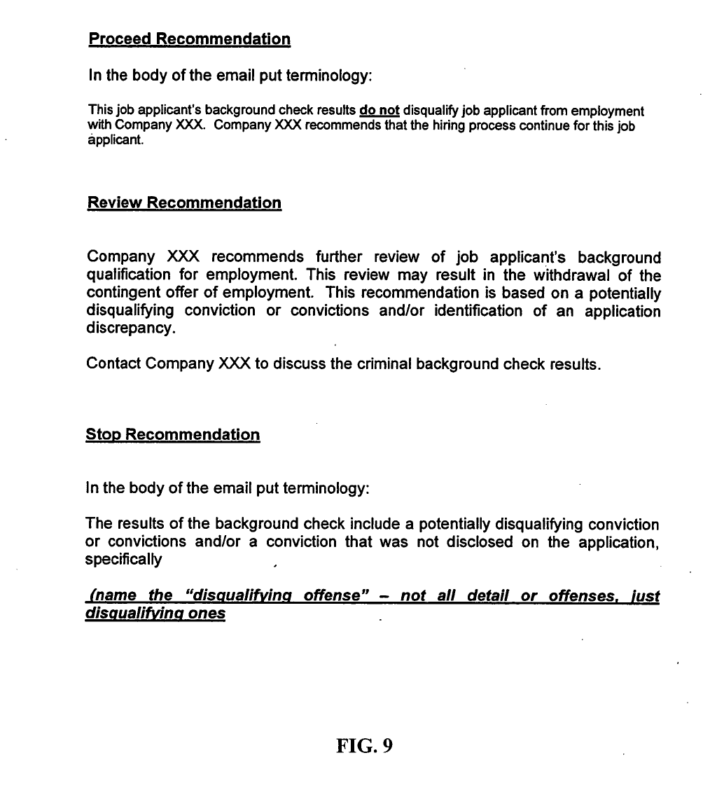

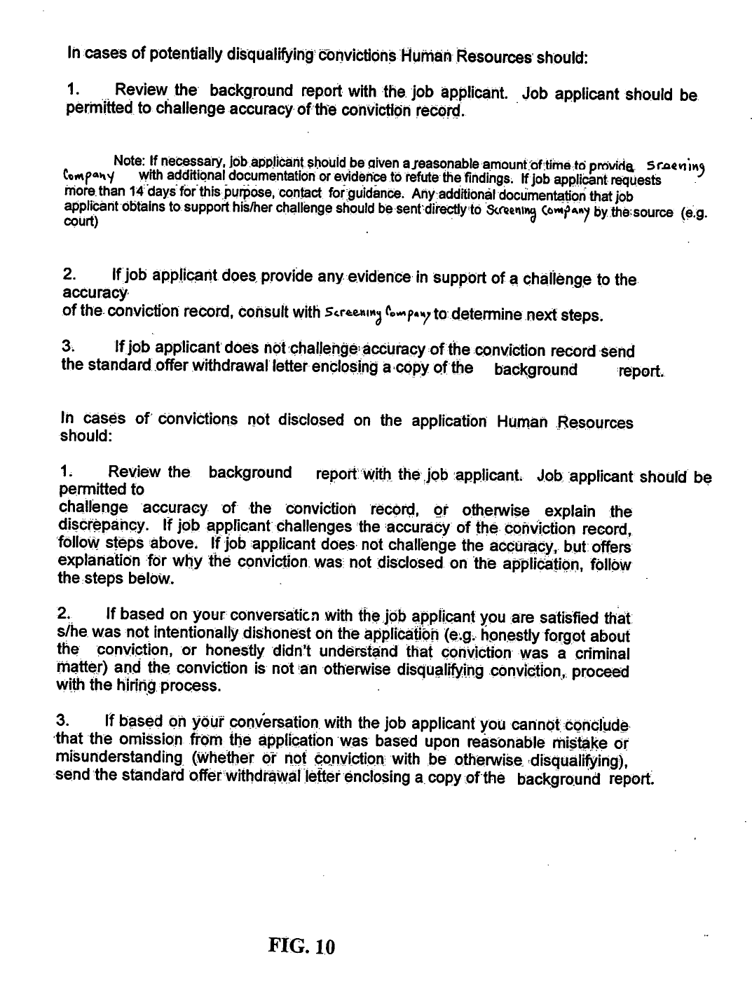

In one embodiment, multiple discrepancies found in the background checks define an action which automatically triggers notification to certain personnel. FIG. 8 is one example of a notification key which links a particular action to contact persons which need to be notified. The format of the notification, the people to notify, and the contents of the notification are all user definable. The means for notifying can also be user-defined and some options contemplated include, E-mails, generation of a notice report or letter, or a paged message. This notification can also include instructions for the appropriate procedures to take with respect to the potential candidate. Examples of notification information are included in FIGS. 9 -10.

In general, the subject invention can be implemented by any computer system having the requisite processing capabilities, software, and memory to implement the steps of the present invention. Preferably the invention is run on a computer server based system having auxiliary memory drives to store the user defined information. The system may be configured to be onsite, and operated within the realm of a human resources department. Alternatively, the system can also be implemented offsite, with subscribers having access to the system through passwords. The system may also be operated on a third party basis and subscribers charged on a per-person basis or on a timed subscription. The subject invention can also be utilized to process one candidate/employee at a time, or it can be used to process a number of candidates/employees at the same time. Processing of a number of candidates/employees at the same time enables the user to benefit from the automated processing of information, and the automated notification processes enable the user to be notified if certain actions are needed with respect to an individual or a group of candidates/employees.

In one embodiment, the subject invention can also generate reports based upon how the candidate/employee pool performed with respect to the set criteria. These reports can be utilized for a number of purposes such as determining if there are inherent faults with the criteria set, or determining if there is a problem with the candidate/employee pool being evaluated, or in determining appropriate policies which can be utilized to remedy the performance of the pool. The format of these reports can be user-defined, and the groups/subgroups which are included in these reports can also be user defined. The subject invention can also include a number of different analysis and report generating tools for evaluating and formatting these reports. The subject information can communicate with or be integrated into an employer's HMRS/HRIS system to provide or perform additional instructions or perform record keeping or additional evaluation.

The subject invention includes a computer implemented system for collecting and analyzing data associated with a job candidate from a plurality of data providers, the system comprising: a discrepancy database that stores customized discrepancy rules (process 15 in FIG. 2); a collection module operable to send an electronic communication to the plurality of reference providers to request information relating to each candidate and to electronically receive data from the plurality of reference providers through a computer network (process 21 in FIG. 2); an analysis module operable to evaluate the received data against the discrepancy database (processes 23-29, 31-33 in FIG. 2); and a reporting module to generate a report based on the evaluations of a pool of candidates (process 30 in FIG. 2), the candidate report being used to further customize said discrepancy database in order to modify the pool size of candidates receiving a positive evaluation.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention.

What is claimed is:

1. A method for processing criminal background information for a plurality of subject individuals comprising:
defining a policy map having a plurality of rules based on crime severity and time interval since crime date;
collecting criminal background information for each subject from a variety of external data sources;
evaluating said collected criminal background information against said policy map for each subject; and
accessing a notification map providing instructions for further processing of said evaluated criminal background information.

2. The method of claim 1 wherein said policy map associates an action of stop, review or proceed for combinations of crime type and said time interval since crime date.

3. The method of claim 1 wherein said further processing includes notification of an action determined by said evaluating.

4. The method of claim 3 wherein said further processing includes compilation of actions determined by said evaluating for a plurality of subjects, said compilation including at least one report summarizing actions taken for each subject.

5. The method of claim 4 further comprising:
updating said policy map based on a review of said at least one report.

6. The method of claim 5 wherein said updating increases a pool of qualified candidates for further consideration.

7. The method of claim 3 wherein said notification includes communication of an action to an HRMS/HRIS system of an employer.

8. A system comprising:
means for associating a plurality of criminal offenses to an action based at least in part on the time since criminal offense;
means for collecting criminal background information for a plurality of candidates;
means for comparing said collected criminal background information with reference to said means for associating; and
notification means for providing a variety of different actions based on said means for comparing.

9. The system of claim 8 further comprising:
means for generating a report summarizing a plurality of actions for said plurality of candidates.

10. The system of claim 9 further comprising:
updating said means for associating so that an increased number of candidates are designated with a proceed or review action.

11. The system of claim 8 wherein said notification means includes communication of information to an HRMS/HRIS system.

12. A system and method for screening a plurality of applicants for employment, comprising: requesting information about each applicant from external information sources; receiving data concerning the applicant from said external information sources; evaluating the applicant for suitability for employment based on evaluating said data received from the external information sources, where the data is evaluated according to a customized set of rules determined by a potential employer; notifying the plurality of candidates of decisions formulated by said evaluating; generating reports relating decisions to candidates; and periodically updating the customized set of rules based on said generated reports.

13. The system and method of claim 12 further comprising:
communicating said decisions and candidate information to an HRMS/HRIS system of the employer for subsequent processing.

14. The system and method of claim 12 wherein said evaluating takes place prior to completion of said receiving of data from said external sources.

15. The system and method of claim 14 further comprising terminating said evaluating upon receipt of a predetermined data from said external sources.

16. A computer implemented system for collecting and analyzing data associated with a job candidate from a plurality of data providers, the system comprising: a discrepancy database that stores customized discrepancy rules; a collection module operable to send an electronic communication to the plurality of reference providers to request information relating to each candidate and to electronically receive data from the plurality of reference providers through a computer network; an analysis module operable to evaluate the received data against the discrepancy database; and a reporting module to generate a report based on the evaluations of a pool of candidates, the candidate report being used to further customize said discrepancy database in order to modify the pool size of candidates receiving a positive evaluation.

17. The system according to claim 16, wherein the collection module is further operable to dynamically receive data through the internet.

18. The system according to claim 16, wherein the analysis module operates while the collection module operates.
